(19) United States
(12) Patent Application Publication
(10) Pub. No.: US 2011/0103659 A1
(43) Pub. Date: May 5, 2011

(54) MEDICAL DIAGNOSTIC SYSTEM AND DATA TRANSMISSION METHOD

(76) Inventor: Yea Chan Choi, Hanam-si (KR)

(21) Appl. No.: 12/913,537

(22) Filed: Oct. 27, 2010

(30) Foreign Application Priority Data
Nov. 2, 2009 (KR) 10-2009-0104791

(51) Int. Cl. G06K 9/00

(52) U.S. Cl. 382/128

(57) ABSTRACT

A medical diagnostic system and a data transmission system are disclosed. The medical diagnostic system includes a medical examination apparatus generating and providing two and three-dimensional image data as a result of diagnosing a target, at least one user terminal, and an image storage-transmission system storing the two and three-dimensional image data provided by the medical examination apparatus and providing the two and three-dimensional image data to the user terminal. The image storage-transmission system provides, in response to a search query about a certain lesion input through the at least one user terminal, at least one thumbnail corresponding to two or three-dimensional image data related to the search query to the user terminal and then provides, in response to selection of a certain thumbnail through the at least one user terminal, two or three-dimensional image data corresponding to the selected certain thumbnail to the user terminal.

### CROSS REFERENCE TO RELATED APPLICATIONS

This application claims the benefit Korean Patent Application No. 10-2009-0104791, filed Nov. 2, 2009, the entire contents of which are incorporated herein by reference.

### BACKGROUND OF THE INVENTION

1. Field of the Invention

The present invention relates to a medical diagnostic system and a data transmission system and, more particularly, to a medical diagnostic system and a data transmission system that can rapidly and efficiently manage and provide a large volume of image data when allowing two or three-dimensional image data of a diagnosis target obtained by a medical examination apparatus to be retrieved on a user terminal.

2. Description of the Related Art

Generally, clinical diagnosis occupies an important role in medical conduct for treating patients. Accurate clinical diagnosis has contributed to the development of clinical technology and dependency on clinical diagnosis will continue to increase in the future.

With the development of computer and communication technology, a system has been studied and developed that provides medical services based on the computer and communication technology in the medical field. For example, there is a picture archiving and communication system (hereinafter, referred to as “PACS”) that employs a computer network constructed in a hospital and includes a database constructed by converting analog data of all X-ray films into digital data and storing the digital data in a large storage medium connected to a system server, so that a user can retrieve a desired X-ray image of a patient on a computer screen in a respective medical room, as needed.

The PACS acquires and transmits clinical images via the high speed network. In the PACS, the clinical images are stored as digital data, instead of the X-ray films that were used to store the clinical images in the past. Accordingly, radiologists and clinical doctors can analyze the clinical images on user terminals such as image retrieval apparatuses and the like. As such, the PACS serves as a comprehensive digital image management and transmission system.

In a conventional medical diagnostic system, an image storage-transmission system such as PACS receives a large volume of two or three-dimensional images, which are generated by a medical examination apparatus, for example, CT, MRI, and the like, and stores the received image data in a compressed state or in an original state. Then, when a user searches for a desired image on a user terminal, the corresponding original image data is retrieved and shown for use thereon or the compressed image data is retrieved and then decompressed for use thereon.

Therefore, since the user terminal serves to retrieve and show a relatively large volume of original two or three-dimensional image data in the conventional medical diagnostic system, the transmission of the large volume of image data consumes a relatively long time and the construction and management of such a medical diagnostic system requires significant costs.

### SUMMARY OF THE INVENTION

The present invention is conceived to solve the problems of the related art, and an aspect of the present invention is to provide a medical diagnostic system and a data transmission system that can rapidly and efficiently manage and provide a large volume of image data when allowing two or three-dimensional image data of a diagnosis target obtained by a medical examination apparatus to be retrieved on a user terminal.

In accordance with one aspect of the present invention, a medical diagnostic system includes a medical examination apparatus configured to generate and transmit image data of a target; an image storage-transmission system configured to receive, store, and transmit the image data and to generate and transmit a thumbnail corresponding to the image data; and a user terminal configured to receive the thumbnail from the image storage-transmission system in response to a search query about a lesion inputted by a user and to receive the image data corresponding to the thumbnail from the image storage-transmission system when the user selects the thumbnail.

In accordance with another aspect of the present invention, a method of transmitting data using a medical diagnostic system including a medical examination apparatus, a user terminal and an image storage-transmission system, includes to generating and transmitting, by the medical examination apparatus, image data of a target to the image storage-transmission system; storing, by the image storage-transmission system, the image data and generating a thumbnail corresponding to the image data; receiving, by the user terminal, the thumbnail in response to a search query about a lesion inputted by a user from the image storage-transmission system; and receiving, by the user terminal, image data corresponding to the thumbnail from the image storage-transmission system when the user selects the thumbnail.

In accordance with one aspect, a medical diagnostic system includes: a medical examination apparatus generating and providing two and three-dimensional image data as a result of diagnosing a target; at least one user terminal; and an image storage-transmission system storing the two and three-dimensional image data provided by the medical examination apparatus and providing the two and three-dimensional image data to the at least one user terminal, wherein the image storage-transmission system provides, in response to a search query about a certain lesion input through the at least one user terminal, at least one thumbnail corresponding to two or three-dimensional image data related to the search query to the at least one user terminal and then provides, in response to selection of a certain thumbnail through the at least one user terminal, two or three-dimensional image data corresponding to the selected certain thumbnail to the at least one user terminal.

In accordance with another aspect, a data transmission system in a medical diagnostic system including a medical examination apparatus, at least one user terminal, and an image storage-transmission system includes: generating and providing, by the medical examination apparatus, two and three-dimensional image data as a result of diagnosing a target to the image storage-transmission system; storing, by the image storage-transmission system, the two and three-dimensional image data; if a search query about a certain lesion is input through the at least one user terminal, providing, by the image storage-transmission system, at least one thumbnail corresponding to two or three-dimensional image data related to the search query to the at least one user terminal; and if a certain thumbnail is selected through the at least one user terminal, providing, by the image storage-transmission system, two or three-dimensional image data corresponding to the selected certain thumbnail to the at least one user terminal.

The image storage-transmission system may store at least one among target information and target diagnosis information in a state of being mapped to the two-dimensional image data, when storing the two-dimensional image data. Further, the image storage-transmission system may provide, in response to the search query, a thumbnail about the certain lesion of a certain target according to a diagnosis time to the at least one user terminal and then provide, in response to the selection of the certain thumbnail through the at least one user terminal, the two or three-dimensional image data corresponding to the selected certain thumbnail to the at least one user terminal.

The image storage-transmission system may store at least one among thumbnail information, link information to the two-dimensional image data, and at least one piece of lesion information in a state of being mapped to the three-dimensional image data, when storing the three-dimensional image data. Further, the image storage-transmission system may provide, in response to the search query, at least one thumbnail about the certain lesion according to targets and then provide, in response to the selection of the certain thumbnail through the at least one user terminal, the two or three-dimensional image data corresponding to the selected certain thumbnail to the at least one user terminal.

### BRIEF DESCRIPTION OF THE DRAWINGS

The above and other aspects, features and advantages of the invention will become apparent from the following detailed description in conjunction with the accompanying drawings, in which:

FIG. 1 is a conceptual view of a medical diagnostic system in accordance with one embodiment of the present invention;

FIG. 2 is a flowchart of a data transmission method in accordance with one embodiment of the present invention;

FIG. 3 is a structural view of image data including two-dimensional image data in accordance with one embodiment of the present invention;

FIG. 4 is a structural view of image data including three-dimensional image data in accordance with one embodiment of the present invention;

FIG. 5 is a view of one example of a retrieval screen provided to a user terminal in accordance with one embodiment of the present invention; and

FIG. 6 is views of two-dimensional images in three-axes in a specific spatial coordinate provided to a user terminal in accordance with one embodiment of the present invention.

### DETAILED DESCRIPTION OF THE EMBODIMENTS

Embodiments of the invention will now be described in detail with reference to the accompanying drawings. It should be noted that these embodiments are given by way of illustration only and do not limit the scope of the invention.

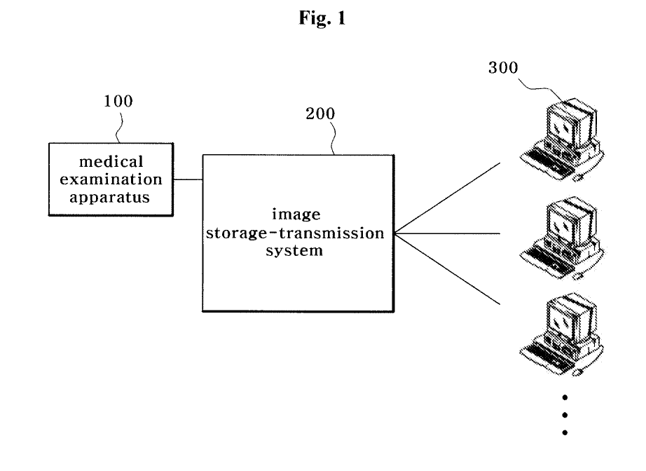

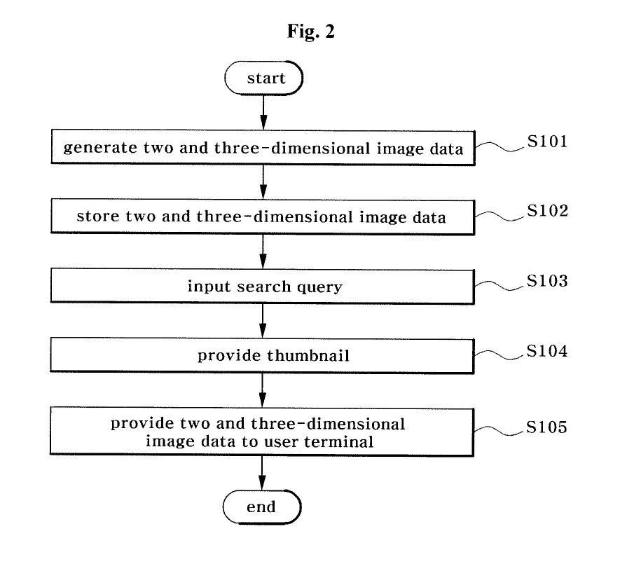

FIG. 1 is a conceptual view of a medical diagnostic system in accordance with one embodiment of the present invention and FIG. 2 is a flowchart of a data transmission method in accordance with one embodiment of the present invention.

Referring to FIG. 1, a medical diagnostic system according to one embodiment includes a medical examination apparatus 100 generating and providing two and three-dimensional image data as a result of diagnosing a target; at least one user terminal 300; and an image storage-transmission system 200 storing the two and three-dimensional image data provided by the medical examination apparatus 100 and providing the two and three-dimensional image data to the at least one user terminal 300. Here, the image storage-transmission system 200 provides, in response to a search query about a certain lesion input through the at least one user terminal 300, at least one thumbnail, corresponding to two or three-dimensional image data related to the search query, to the at least one user terminal 300 and then provides, in response to selection of a certain thumbnail through the at least one user terminal 300, two or three-dimensional image data corresponding to the selected certain thumbnail to the at least one user terminal 300.

Constitution and operation of the medical diagnostic system according to the embodiment will now be described.

Referring to FIG. 2, first, the medical examination apparatus 100, for example, a magnetic resonance imaging (MRI) scanner, a computer tomography (CT) scanner, or the like, generates and transmits two and three-dimensional image data, as a result of diagnosing a target of a patient, to the image storage-transmission system 200 in S101.

Then, the image storage-transmission system 200 receives and stores the two and three-dimensional image data in S102. Herein, the term “image storage-transmission system 200” generally refers to a system such as PACS that stores and transmits clinical images to user terminals.

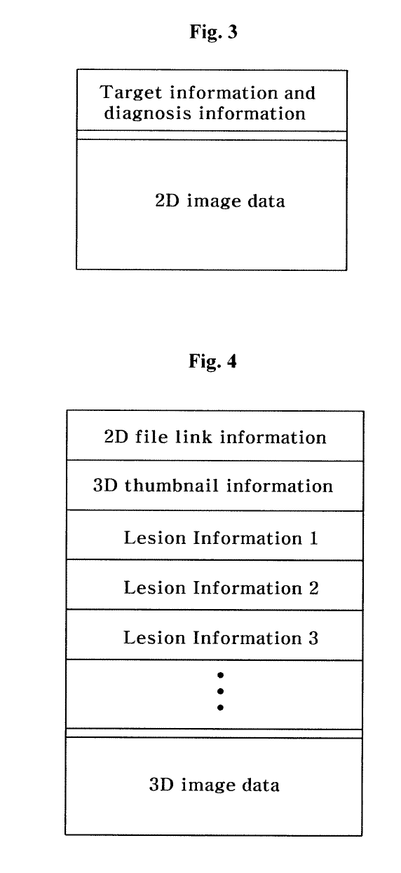

As shown in FIG. 3, when storing the two-dimensional image data, the image storage-transmission system 200 maps at least one piece of information among target information and target diagnosis information to the two-dimensional image data and stores the at least one piece of information as header information. Herein, the term “target information” means information about the target, that is, characteristics of a patient and the like, and the term “target diagnosis information” means information about general diagnosis conditions, such as a diagnosis date, diagnosis equipment, and the like.

Further, as shown in FIG. 4, when storing the three-dimensional image data, the image storage-transmission system 200 maps at least one piece of information among thumbnail information, link information to the two-dimensional image data and at least one piece of lesion information, and stores the at least one piece of information as header information.

Herein, the term “thumbnail information” refers to information about a thumbnail corresponding to the three-dimensional image data provided as original data and the thumbnail means a reduced image or a reduced version of the three-dimensional image data for facilitating retrieval and viewing by a user on the user terminal 300. Although the medical examination apparatus 100 can be configured to generate the thumbnail information, it is advantageous to generate the thumbnail information from the image storage-transmission system 200 to reduce the load of the medical examination apparatus 100 while enhancing overall efficiency of the system.

Further, the at least one piece of lesion information may include all pieces of comprehensive information about lesion, such as a location, characteristics, and the like, or may selectively include some pieces of information among them. Here, one or more pieces of lesion information, such as Lesion Information 1, Lesion Information 2, Lesion Information 3, etc., may be mapped to at least one three-dimensional image, as shown in FIG. 4. For example, when three-dimensional image data for the heart of a patient is stored, lesion information about respective detailed portions of the heart, such as lesion information of the left ventricle, lesion information of the right ventricle, etc., may be mapped and stored to the three-dimensional image data of the heart.

Next, the at least one user terminal 300 receives a search query about a certain lesion input by a user in S103. The search query may be a search query for retrieving image data about the certain lesion of a certain target classified according to diagnosis times (for example, diagnosis dates) or a search query for retrieving image data about the certain lesion classified according to targets. It should be understood that a variety of search queries may be used in the system according to embodiments.

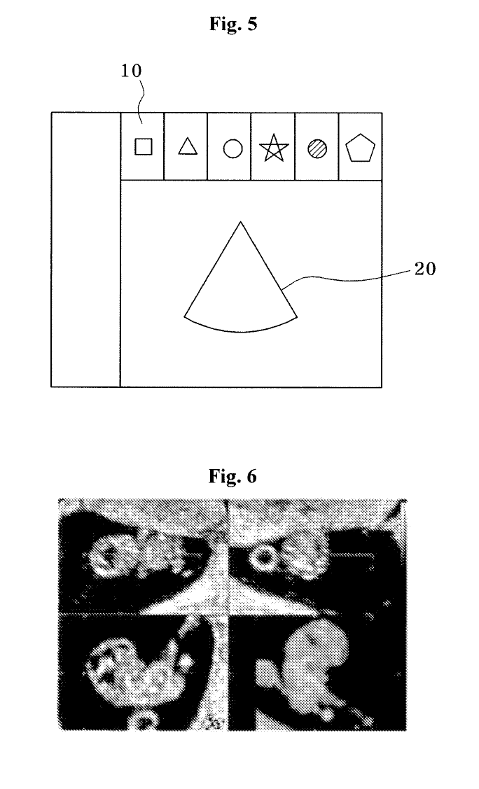

Then, in response to the search query input to the user terminal 300, the image storage-transmission system 200 provides at least one thumbnail 10, corresponding to two or three-dimensional image data related to the search query, to the user terminal 300 in S104. Namely, the image storage-transmission system 200 provides the at least one thumbnail 10, corresponding to the two or three-dimensional image data related to the input search query, to a user through a screen of the user terminal, as shown in FIG. 5.

When there is a need to provide two-dimensional image data according to characteristics of the input search query, the image storage-transmission system 200 provides the two-dimensional image data related to the search query to the user terminal 300 so as to be displayed as a reduced image in the form of a thumbnail, as shown in FIG. 5. For example, if the search query is input to retrieve image data about a certain lesion of a certain target according to diagnosis times, the image storage-transmission system 200 provides two-dimensional image data related to the search query to the user terminal 300 using target information, target diagnosis information, and the like stored as the header information of the two-dimensional image data therein. Alternatively, according to one embodiment, the image storage-transmission system 200 may provide thumbnails of the three-dimensional image data in response to the search query by adding link information to the three-dimensional image data stored as the header information of the two-dimensional image data.

On the other hand, according to one embodiment, the image storage-transmission system 200 may generate and provide thumbnails of the two-dimensional image data to the user terminal 300 or may map 2D thumbnail information to the two-dimensional image data so that the 2D thumbnail information is included as the header information in a data structure when storing the two-dimensional image data.

Further, when there is a need to provide three-dimensional image data according to characteristics of the input search query, the image storage-transmission system 200 provides thumbnail information of the three-dimensional image data related to the search query to the user terminal 300. For example, if the search query is input to retrieve image data about a certain lesion classified according to targets, the image storage-transmission system 200 provides thumbnail information of three-dimensional image data related to the search query to the user terminal 300 using lesion information stored as the header information of the three-dimensional image data and allows the corresponding thumbnails 10 to be displayed on the screen of the user terminal 300, as shown in FIG. 5.

Here, since original three-dimensional image data have a very large volume, the image storage-transmission system 200 transmits only the thumbnail information corresponding to the original three-dimensional image data instead of transmitting all of the original three-dimensional image data, thereby enhancing speed and efficiency in information retrieval while reducing transmission load. It should be understood that, for two-dimensional image data which have a lower volume than the three-dimensional image data, thumbnails of the two-dimensional image data may be provided to the user terminal 300 instead of the original data thereof, thereby providing the same effect as mentioned above.

According to one embodiment, the image storage-transmission system 200 may provide thumbnails of the two-dimensional image data in response to the search query by adding link information to the two-dimensional image data stored as the header information of the three-dimensional image data.

Finally, if a certain thumbnail is selected through the user terminal 300, the image storage-transmission system 200 provides two or three-dimensional image data corresponding to the selected certain thumbnail to the user terminal 300 in response to the selection of the certain thumbnail in S105. In other words, when the certain thumbnail is selected among the thumbnails provided to the user terminal 300 in response to the input search query, the image storage-transmission system 200 provides the two or three-dimensional image data corresponding to the selected certain thumbnail to the user terminal 300 so that a user can retrieve an original image.

Here, since the three-dimensional image data includes link information to two-dimensional image data, which is mapped to the three-dimensional image data and stored as the header information, the image storage-transmission system 200 may be configured to allow a user to retrieve the associated two-dimensional image data using the link information during retrieval of the three-dimensional image data.

Further, the image storage-transmission system 200 may be configured to provide additional two-dimensional images viewed along three-axes, for example, along the x-axis, the y-axis and the z-axis, in a specific spatial coordinate (x, y, z) according to user selection, as shown in FIG. 6, when providing the three-dimensional image data corresponding to the selected thumbnail. Here, the two-dimensional images viewed along the three-axes are data previously obtained by the medical examination apparatus 100 and used to form three-dimensional images, and the image storage-transmission system 200 previously stores sources of the two-dimensional images to provide the stored sources to a user, thereby enhancing user convenience.

In the embodiments, the medical diagnostic system and the data transmission system provide thumbnails corresponding to respective original image data so as to be retrieved by a user, instead of directly providing the original image data, in a search query stage, when retrieving two or three-dimensional image data of a diagnosis target obtained from a medical examination apparatus on a user terminal, thereby allowing rapid retrieval of desired image data while enabling efficient management of the image data.

Further, in the embodiments, the medical diagnostic system and the data transmission system enable a user to retrieve image data about a certain lesion of a certain target according to a respective diagnosis time, various image data about a certain lesion according to targets, and the like, using a search query input through a user terminal, thereby significantly enhancing user convenience and speed in retrieval of desired image data.

Although some embodiments have been provided to illustrate the invention in conjunction with the drawings, it will be apparent to those skilled in the art that the embodiments are given by way of illustration only, and that that various modifications, changes, alterations, and equivalent embodiments can be made without departing from the spirit and scope of the invention. The scope of the invention should be limited only by the accompanying claims.

What is claimed is:

1. A medical diagnostic system comprising:
a medical examination apparatus configured to generate and transmit image data of a target;
an image storage-transmission system configured to receive, store, and transmit the image data and to generate and transmit a thumbnail corresponding to the image data; and
a user terminal configured to receive the thumbnail from the image storage-transmission system in response to a search query about a lesion inputted by a user and to receive the image data corresponding to the thumbnail from the image storage-transmission system when the user selects the thumbnail.

2. The system of claim 1, wherein the image data comprises two and three dimensional image data and the image storage-transmission system stores at least one among target information and target diagnosis information in a state of being mapped to the two-dimensional image data when storing the two-dimensional image data.

3. The system of claim 2, wherein the image storage-transmission system provides, in response to the search query, at least one thumbnail about a certain lesion of a certain target according to diagnosis times and then provides, in response to the selection of the thumbnail through the user terminal, the two or three-dimensional image data corresponding to the selected certain thumbnail to the user terminal.

4. The system of claim 1, wherein the image data comprises two and three dimensional image data and the image storage-transmission system stores at least one among thumbnail information, link information to the two-dimensional image data, and at least one piece of lesion information in a state of being mapped to the three-dimensional image data, when storing the three-dimensional image data.

5. The system of claim 4, wherein the image storage-transmission system provides, in response to the search query, at least one thumbnail about the certain lesion according to targets and then provides, in response to the selection of the thumbnail through the user terminal, the two or three-dimensional image data corresponding to the selected certain thumbnail to the user terminal.

6. The system of claim 4, wherein the medical diagnostic system allows the two-dimensional image data to be retrieved using the link information to the two-dimensional image data, when retrieving the three-dimensional image data.

7. The system of claim 1, wherein the image storage-transmission system additionally provides a two-dimensional image viewed along any of three-axes in a specific spatial coordinate when providing the three-dimensional image data.

8. The system of claim 1, wherein the thumbnail is generated by the image storage-transmission system.

9. A data transmission method of a medical diagnostic system including a medical examination apparatus, a user terminal and an image storage-transmission system, the method comprising:
generating and transmitting, by the medical examination apparatus, image data of a target to the image storage-transmission system;
storing, by the image storage-transmission system, the image data and generating a thumbnail corresponding to the image data;
receiving, by the user terminal, the thumbnail in response to a search query about a lesion inputted by a user from the image storage-transmission system; and
receiving, by the user terminal, image data corresponding to the thumbnail from the image storage-transmission system when the user selects the thumbnail.

10. The method of claim 9, wherein the image data comprises two and three dimensional image data and the image storage-transmission system stores at least one among target information and target diagnosis information in a state of being mapped to the two-dimensional image data when storing the two-dimensional image data.

11. The method of claim 10, wherein the user terminal receives, in response to the search query, at least one thumbnail about a certain lesion of a certain target according to diagnosis times from the image storage-transmission system.

12. The method of claim 9, wherein the image data comprises two and three dimensional image data and the image storage-transmission system stores at least one among thumbnail information, link information to the two-dimensional image data, and at least one piece of lesion information in a state of being mapped to the three-dimensional image data, when storing the three-dimensional image data.

13. The method of claim 12, wherein the image storage-transmission system provides, in response to the search query, at least one thumbnail about the lesion according to targets, when providing the two or three-dimensional image data corresponding to the selected thumbnail.

14. The method of claim 9, wherein the image data comprises a two-dimensional image viewed along any of three-axes in a specific spatial coordinate.
